(19) United States
(12) Patent Application Publication
(10) Pub. No.: US 2012/0057172 A1
(43) Pub. Date: Mar. 8, 2012

(54) OPTICAL MEASURING SYSTEM WITH ILLUMINATION PROVIDED THROUGH A VOID IN A COLLECTING LENS

(76) Inventors: Andrei Brunfeld, Cupertino, CA (US); Gregory Toker, Jerusalem (IL); Bryan Clark, Mountain View, CA (US); Morey T. Roscrow, Milpitas, CA (US)

(21) Appl. No.: 12/877,527

(22) Filed: Sep. 8, 2010

(51) Int. Cl. G01B 11/02; G01B 11/24; G01N 21/00

(52) U.S. Cl. 356/511; 356/237.1; 356/601

(57) ABSTRACT

An optical measuring system includes a scatterometer in which an illumination beam is provided through an aperture in a lens used to collect light for the scattering detection. The void may be a slit in the lens, a missing portion along an edge of the lens, or another suitable void. Another detection channel may be provided to detect light returning through the void in the collecting lens, for example, a profilometer may be implemented by detecting interference between reflected light returning along the illumination path and light from the illumination source.

The present Application is related to co-pending U.S. patent application Ser. No. 12/877,480 entitled “OPTICAL MEASURING SYSTEM WITH MATCHED COLLECTING LENS AND DETECTOR LIGHT GUIDE” filed on Sep. 8, 2010 by the same inventors, and which is incorporated herein by reference.

### BACKGROUND OF THE INVENTION

1. Field of the Invention

This invention relates to optical measurement and inspection systems, and more specifically, to an optical inspection head and system in which illumination of a surface under inspection is provided through a void in a collecting lens that is used to collect light for scattering detection.

2. Background of the Invention

Optical surface inspection systems are in common use in industry for both analysis and manufacturing test operations. The optical heads used to provide measurements when scanning a surface may combine multiple types of detection. For example, U.S. Pat. No. 7,671,978, issued to the inventors of the present application, discloses optical heads that include both an interferometer and a scatterometer channel. In other applications, single channel systems are used.

In the above-described optical inspection systems, illumination is either provided through the lens, in which case the lens is typically quite large in order to accommodate the injection of the illumination beam and in order to provide a wide collection angle for light returning from the surface under inspection, or outside of the lens, in which case either the illumination source is typically inclined away from normal to the surface under inspection. In systems in which the illumination source is inclined, the detection sensitivity becomes asymmetrical and polarization-dependent. In systems in which the illumination source is not inclined, it is also difficult to provide a dark field measurement, since background surface noise scatters in a direction normal to the surface. Attempting to baffle the surface noise typically results in attenuating the desired scattering signal as well.

Dark field detectors are also sensitive to stray light sources and leakage along the optical path. In particular, scattering detectors or scatterometers, are extremely sensitive to parasitic light originating in so-called “ghost images” in the optical system, and to reflection and re-scattering of ambient light. Further, when inspecting transparent objects, scattering from the back side of the object and from within the object also generate undesired images. Non-imaging dark field detectors such as integrating spheres are also sensitive to ambient light, since the sphere will collect light from all directions. Therefore, such systems are generally additionally bulky, since optical isolation is required to achieve desired levels of sensitivity.

Therefore, it would be desirable to provide a compact dark field scattering detection system with isolation between the detection path(s) and the illumination beam.

### SUMMARY OF THE INVENTION

The foregoing objectives are achieved in an optical system and method for optical inspection. The inspection system includes an illumination system that generates an illumination spot on a surface under inspection and a collecting lens that collects light scattered from the portion of the surface under inspection under the illumination spot. The illumination system directs a beam through a void passing through the collecting lens, to prevent generation of any ghost image or additional scattering by the collecting lens. The system also includes a detector for detecting the light collected by the collecting lens.

The void may be a slit across the collecting lens, a missing portion along the edge of the lens, or another suitable void through which illumination can be directed. A profilometer channel or other optical measurement channel may measure light returning through the void in the collecting lens. For example, a profilometer may be implemented using a beam splitter that detects interference of light reflected along the path of the illumination to measure surface height.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting an optical inspection system in accordance with an embodiment of the present invention.

FIG. 2 is a pictorial diagram depicting an optical system in accordance with an embodiment of the present invention.

FIG. 3 is a pictorial diagram depicting an optical system in accordance with another embodiment of the present invention.

FIGS. 4A-4C are pictorial diagram depicting optical systems in accordance with still other embodiments of the present invention.

FIGS. 5A-5C are pictorial diagram depicting lenses that may be employed in the systems of FIGS. 2-3 and 4A-4B.

FIG. 6 is a pictorial diagram depicting an optical system in accordance with yet another embodiment of the present invention.

### DESCRIPTION OF ILLUSTRATIVE EMBODIMENT

The present invention encompasses optical inspection systems in which a lens is used to capture light scattered from an illuminated spot on a surface under inspection. An illumination sub-system directs the illumination through a void passing through the collecting lens to generate the illumination spot, preventing generation of ghost images or additional scattering that may enter a detection path that includes the lens.

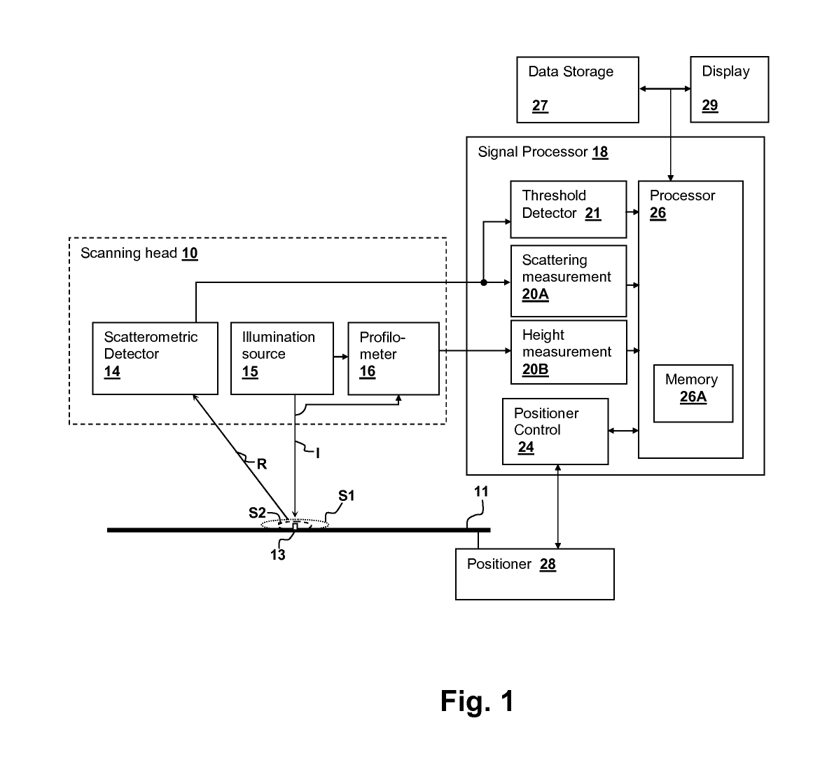

Referring now to FIG. 1, an optical inspection system in accordance with an embodiment of the present invention is shown. A scanning head 10 is positioned over a surface under inspection 11, which is moved via a positioner 28 that is coupled to a signal processor 18. From scanning head 10, illumination I of surface under inspection 11 is provided by an illumination source 15. A scattering detector 14 receives light scattered from surface under inspection 11 along optical path R from an illumination spot S generated by illumination I. Scatterometric optical path R gathers light from one or more non-specular angles with respect to illumination I and surface under inspection 11, so that light scattered from an artifact 13 (which may be a surface defect or feature, or an extraneous particle) disposed on surface under inspection 11, indicates the presence of the artifact. A profilometer 16 may also be included, such as an interferometer channel that interferes light returning along the illumination path, or another optical path and combines the returned light with light directly coupled from illumination source 15 to determine the height of surface under inspection 11 within illumination spot S.

In the optical system of the present invention, the light for generating illumination spot S is directed through a void that passes through the aperture of a collecting lens. The void may be a hole passing through the collecting lens, or a missing portion of the lens material that extends to the edge of the collecting lens. By illuminating surface under inspection 11 directly, ghost images and/or stray light generated by the illumination beam striking material boundaries is avoided. By providing the illumination through an aperture in the collecting lens, the collecting lens can be made larger and/or placed closer to illumination spot S without requiring that an illumination beam pass through the collecting lens material.

While the illustration shows a positioner 28 for moving surface under inspection under scanning head 10, it is understood that scanning head 10 can be moved over a fixed surface, or that multiple positioners may be employed, so that both scanning head 10 and surface under inspection 11 may be moved in the measurement process. Further, while scattering detector 14 and illumination source 15 are shown as included within scanning head 10, optical fibers and other optical pathways may be provided for locating scattering detector 14 and illumination source(s) 15 physically apart from scanning head 10.

Signal processor 18 includes a processor 26 that includes a memory 26A for storing program instructions and data. The program instructions include program instructions for controlling positioner 28 via a positioner control circuit 24, and performing measurements in accordance with the output of scatterometric detector 14 via scatterometer measurement circuit 20A that include signal processing and analog-to-digital conversion elements as needed for receiving the output of scatterometric detector 14. Profilometer channel 16 is coupled to a height measurement circuit 20B that provides an output to processor 26. A dedicated threshold detector 21 can be employed to indicate to processor 26 when scattering from an artifact 13 on surface under measurement 11 has been detected above a threshold. As an alternative, continuous data collection may be employed. Processor 26 is also coupled to an external storage 27 for storing measurement data and a display device 29 for displaying measurement results, by a bus or network connection. External storage 27 and display device 29 may be included in an external workstation computer or network connected to the optical inspection system of the present invention by a wired or wireless connection.

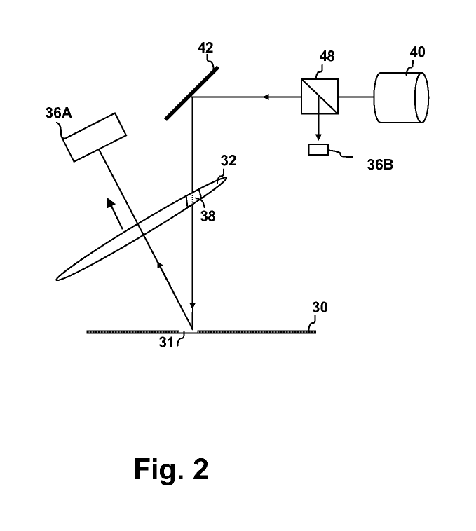

Referring now to FIG. 2, an optical system in accordance with another embodiment of the present invention is shown, which may be included within scatterometric detector 14 of FIG. 1. In the depicted embodiment, an illumination source 40 is positioned over surface under inspection 30 and the illumination beam produced by illumination source 40 is directed at surface under inspection to produce illumination spot 31 by bending mirror 42. The illumination beam is directed through a void 38 passing through a collecting lens 32, so that no ghost reflections are generated by scattering off of surfaces of, or material internal to, collecting lens 32. Light scattered by artifacts within illumination spot 31 is collected by collecting lens 32, which may have a large numerical aperture. Light collected by collecting lens 32 is directed to a detector 36A, which may be a point detector, or an array of detection elements in one or two dimensions. The collection axis, defined by the center of collecting lens 32 and illumination spot 31, is rotated at an angle other than the direction of the illumination beam, so that spatial separation is provided between the axes of the illumination and the scattered light being detected. Void 38 is in the form of a slit in collecting lens 32, but may take other forms and may be located at an edge of collecting lens 32. The angle of tilt between the illumination and collection axes will generally range from about 3 degrees to 30 degrees away from the direction normal to surface under inspection 11.

Detector 36A may additionally be a focal plane array, a linear array of individual detectors such as avalanche photodiodes, a coherent fiber optics bundle that is coupled to a detector array or individual detectors, a microchannel image intensifier plate (MCP), or another suitable optical detector or detector array. Further details of suitable collecting lens arrangements for coupling collecting lens 32 to detector 36A, are illustrated in the above-incorporated U.S. patent application “OPTICAL MEASURING SYSTEM WITH MATCHED COLLECTING LENS AND DETECTOR LIGHT GUIDE.” The techniques disclosed therein may be used in conjunction or alternative to the techniques disclosed herein.

The optical system of FIG. 2 may optionally include a second optical subsystem for making measurements on specularly-reflected light. A detector 36B, which may be a bright-field interferometer, a deflectometer or another suitable measurement subsystem for measuring a characteristic of the light specularly reflected by surface of interest 30 and returned to detector 36B, through void 38 in collecting lens 32. A beam-splitter 48 is included to direct the reflected light to detector 36B. In one embodiment of the optical system of FIG. 2, a diffraction pattern of the specularly-reflected light can be imaged on to a two-dimensional array detector or camera 36A to provide detailed angular scattering information for locating an artifact on surface under inspection 30.

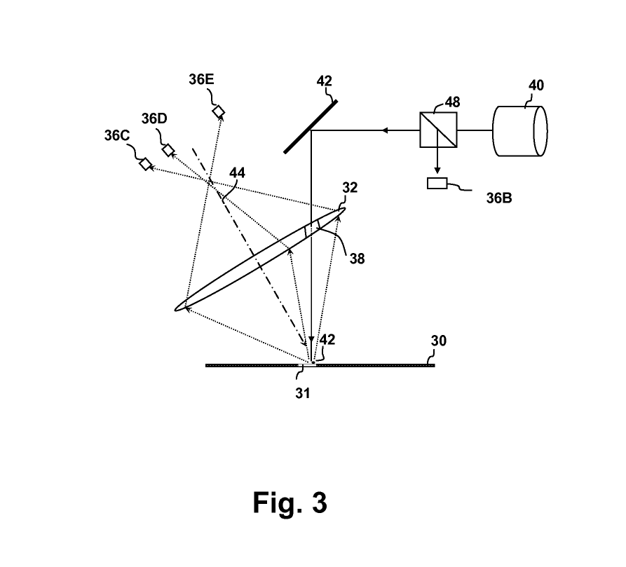

Referring now to FIG. 3, another optical system in accordance with another embodiment of the invention is shown. The optical system of FIG. 3 is similar to the optical system of FIG. 2, except for differences that will be described in further detail below. In the optical system of FIG. 3, the first optical system includes a plurality of detectors 36C, 36D and 36E that are separate and distinct. Each of detectors 36C-36E may be a point detector for detecting light scattered from surface under inspection 30 at a particular angle, or some of 36C-36E may be array detectors. For example, detector 36C may be a point detector and detectors 36D-36E may be linear array detectors oriented in two different directions.

The optical system of FIG. 3 also includes a second optical subsystem for detection of the specular reflection of the illumination (bright field), which may be a deflectometer, an inteferometric profilometer, or any other suitable system for bright field detection. A detector 36B provides detection for the second optical subsystem, and if the second optical subsystem is a deflectometer, detector 36B is a position detector, detecting angular variation of surface under inspection 30 by the deflection of the specular beam. If the second optical subsystem is an interferometer, a reference beam coupled from illumination source 40 and light returned along the illumination optical path from surface under inspection 30 is interfered by a beam splitter/combiner 46 that provides an input to detector 36B, that measures variations of height of surface under inspection 30. Therefore, in the optical system of FIG. 3, both illumination and one optical measurement channel are provided through the void in collecting lens 32, so that collecting lens 32 does not disrupt any measurement made by the second optical subsystem.

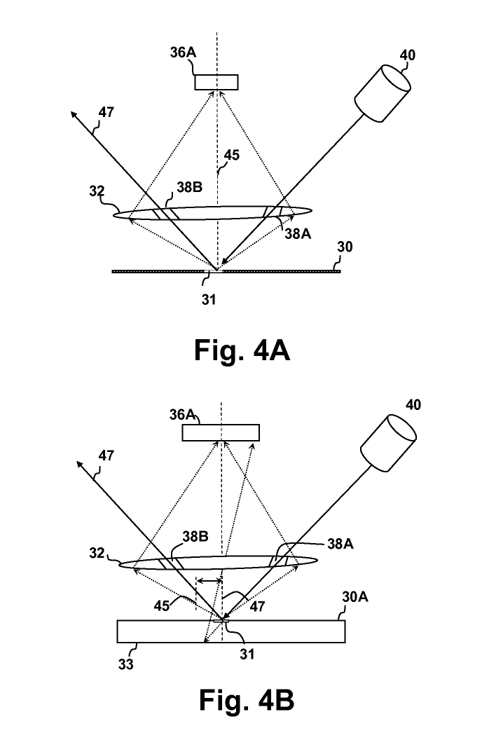

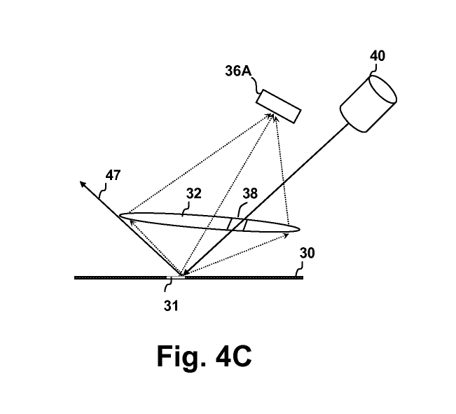

Referring now to FIG. 4A, an optical system in accordance with yet another embodiment of the invention is shown. The optical system of FIG. 4A is similar to the optical system of FIG. 2, except for differences that will be described in further detail below. In the optical system of FIG. 4A, the optical axis of collecting lens 32 is oriented at a direction normal to surface under inspection, and illumination subsystem 40 is aligned to tilt the illumination optical path through void 38A to generate illumination spot 31 on surface under inspection 30. The specular reflection from surface under inspection 30 passes through a second void 38B in collecting lens 32, so that the specularly reflected light minimally interacts with collecting lens 32. As described above, scattered light collected by collecting lens 32 is directed to detector 36A, so that the optical axis 45 of collecting lens 32 is centered on illumination spot 31. The specular reflection can be used by a second optical subsystem as in the optical system of FIG. 3 described above. While it is generally desirable to provide the illumination normal to surface under inspection 30 to avoid generation of preferred directions or stray light artifacts due to the tilt of the illumination beam, the optical system of FIG. 4A illustrates that the techniques of the present invention may be employed with illumination directed at other-than-normal incidence to permit optical axis 45 of collecting lens 32 to be oriented normal to surface under inspection 30 and directly above illumination spot 31 without locating void 38A in the center of collecting lens 32.

Referring now to FIG. 4B, an optical system in accordance with yet another embodiment of the invention is shown. The optical system of FIG. 4B is similar to the optical system of FIG. 4A, except for differences that will be described in further detail below. In the optical system of FIG. 4B, collecting lens 32 directs light reflected from a bottom surface of a transparent article 33 to a different location on detector 36A than light reflected from a top surface of transparent article 33. With this arrangement, the depth at which light is scattered is translated to a displacement across the aperture detector 36A, providing a mechanism by which a depth of internal features of transparent article 33 is revealed and can be measured. If detector 36A is a point detector, then the configuration described above yields a measurement depth within transparent article 33 from which scattered light will be selectively detected.

Referring now to FIG. 4C, an optical system in accordance with still another embodiment of the invention is shown. The optical system of FIG. 4C is similar to the optical system of FIG. 4A, except for differences that will be described in further detail below. In the optical system of FIG. 4C, the optical axis of collecting lens 32 is offset from the center of illumination spot 31 and may also be rotated as shown with respect to surface under inspection 30, so that the reflected beam 47 misses collecting lens 32, obviating the need for a second slit to pass reflected beam 47.

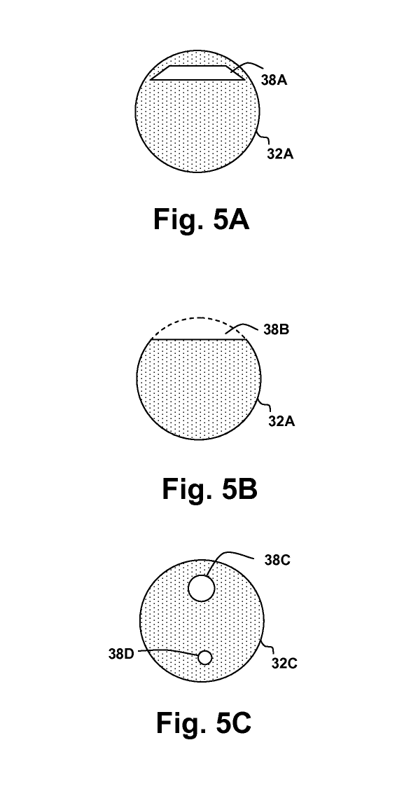

Referring now to FIGS. 5A-5C, examples of collecting lenses that may be used to implement collecting lens 32 in the optical systems described herein are shown. Lens 32A, shown in FIG. 5A, has a quasi-rectangular void 38A passing through the material of lens 32A, in the form of a slit, which may be made as narrow as the width of the illumination beam. The ends of void 48A may be straight, as shown, or curved to match the circumference of lens 32A. Lens 32B, shown in FIG. 5B, has a void 38B in the form of a segment of the material of lens 32B that is removed from an edge of lens 32B. Therefore, void 38B does not pass through the material of lens 32B, but does pass through the aperture defined by lens 32B if lens 32B where whole. Within the context of the present invention, a void passing through the collecting lens is understood to encompass both voids that pass through the material of the collecting lens, as well as voids that pass through an aperture or outline defined by collecting lens, but in which lens material has been removed from an edge. Edge material may be defined by a single chord as illustrated, or another shape such as a rotational segment (pie segment) may be removed from the collecting lens.

FIG. 5C illustrates another lens 32C that may be used in the optical systems described above. Lens 32C includes two voids 38C and 38D, that may be circular in cross-section, as illustrated, or one or more of voids 38C and 38D may have another shape as described above. Void 38D may be used, for example, to provide for passage of the illumination beam to surface under inspection 30 in an optical system such as that illustrated in FIG. 4A, while void 38C may provide for exit of reflected light that is then captured by a profilometer detector added to the optical system of FIG. 4A and oriented at the appropriate angle opposite illumination source 40.

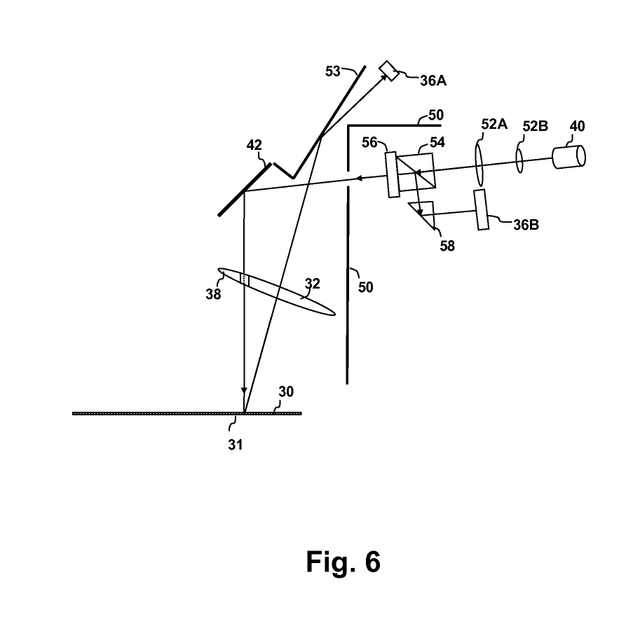

Referring now to FIG. 6, an optical system in accordance with still another embodiment of the present invention is shown. The optical system of FIG. 6 is similar to the optical system of FIG. 3, so only differences between them will be described below. The optical system of FIG. 6 illustrates additional details and features over those depicted in FIG. 3, including absorbing baffles 50 and a folding mirror 53 that provide further isolation from stray light sources within the system and to separate the bright-field (specular) optical detection system from the scattering channels/optical subsystems. Light scattered from surface under inspection 30 and collected by collecting lens 32 is directed to detector 36A by folding mirror 53, while folding mirror 42 directs the illumination beam provided from illumination source 40, collimated by collimating lens 52B and focused by focusing lens 52A. The illumination beam is directed through a polarizing beam-splitter 54 that includes a quarter-wave plate 56 to form an optical isolator for the bright-field (specular) optical detection subsystem.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. An optical measurement system, comprising:
an illumination subsystem for directing an illumination beam at a surface under inspection;
a first optical subsystem for measuring a first characteristic of the surface under inspection, wherein the first optical subsystem includes a collecting lens for collecting light returned from the surface under inspection from the illumination beam and a first detector for detecting an intensity of the light collected by the collecting lens, wherein the collecting lens defines a void passing through the collecting lens and devoid of any lens material, and wherein the illumination subsystem directs the illumination system through the void passing through the collecting lens.

2. The optical measurement system of claim 1, further comprising a second optical subsystem for measuring a second characteristic of the surface under inspection, wherein light returned from the surface under inspection to a second detector of the second optical subsystem passes through the void in the collecting lens of the first optical subsystem.

3. The optical measurement system of claim 2, wherein the first optical subsystem is a detector for detecting an intensity of light returned from a feature or deposit on the surface under inspection at one or more angles.

4. The optical measurement system of claim 3, wherein the first detector of the first optical subsystem comprises an array of detectors extending in at least one dimension.

5. The optical measurement system of claim 4, wherein the array of detectors is a two-dimensional array.

6. The optical measurement system of claim 3, further comprising one or more additional specular detectors for detecting an intensity of light returned from a feature or deposit on the surface under inspection at one or more additional angles.

7. The optical measurement system of claim 2, wherein the second optical subsystem detects light reflected from the surface under inspection.

8. The optical measurement system of claim 7, wherein the second detector of the second optical subsystem includes an array of detectors extending in at least one dimension.

9. The optical measurement system of claim 8, wherein the second detector of the second optical subsystem is a two-dimensional array.

10. The optical measurement system of claim 2, wherein the second optical subsystem is an interferometric profilometer.

11. The optical measurement system of claim 2, wherein the second optical subsystem is a deflection profilometer.

12. The optical measurement system of claim 1, wherein the first optical subsystem is a scatterometer and the collecting lens collects light scattered from the surface under inspection.

13. The optical measurement system of claim 1, wherein the illumination beam is substantially normal to the surface under inspection.

14. The optical measurement system of claim 1, wherein an optical axis of the first optical subsystem is directed at an angle other than normal to the surface under inspection.

15. The optical measurement system of claim 14, wherein the angle other than normal is between three and thirty degrees away from normal to the surface under inspection.

16. The optical measurement system of claim 15, wherein the illumination beam is directed at the surface under inspection at an angle other than normal to the surface under inspection.

17. The optical measurement system of claim 1, wherein the illumination beam is directed at the surface under inspection at an angle other than normal to the surface under inspection.

18. The optical measurement system of claim 1, wherein the collecting lens further defines a second void passing through the collecting lens and devoid of any lens material for return of a specular beam of light, specularly reflected from the surface under inspection.

19. The optical measurement system of claim 1, wherein an axis of the first optical subsystem is offset in rotation from an axis of illumination of the illumination subsystem.

20. The optical measurement system of claim 19, wherein an optical axis of the first optical subsystem is directed at an angle substantially normal to the surface under inspection.

21. The optical measurement system of claim 1, wherein the void is a slit in the collecting lens having two substantially parallel sides.

22. The optical measurement system of claim 1, wherein the void is a substantially circular hole passing through the collecting lens.

23. The optical measurement system of claim 1, wherein the collecting lens has a substantially circular profile perpendicular to an optical axis of the collecting lens, and wherein the void is a region at the edge of the lens and intersecting the circular profile.

24. The optical measurement system of claim 1, wherein the collecting lens of the first optical subsystem further defines a second void passing through the collecting lens and devoid of any lens material, further comprising a second optical subsystem for measuring a second characteristic of the surface under inspection, wherein light returned from the surface under inspection to a second detector of the second optical subsystem passes through the second void in the collecting lens of the first optical subsystem.

25. The optical measurement system of claim 1, wherein the surface under inspection is a top surface of a transparent object, and wherein the first detector indicates a depth of scattering from the transparent object beneath the surface under inspection as a displacement across a detection field of the detector.

26. A method of performing optical measurements, comprising:
directing an illumination beam at a surface under inspection through a void defined by and passing through a collecting lens of a first optical subsystem, wherein the void is devoid of any lens material of the collecting lens;
measuring a first characteristic of the surface under inspection using the first optical subsystem by collecting light returned from the surface under inspection from the illumination beam using the collecting lens; and
first detecting an intensity of the light collected by the collecting lens.

27. The method of claim 26, further comprising measuring a second characteristic of the surface under inspection using a second optical subsystem by second detecting a characteristic of light returned from the surface under inspection to a second detector of the second optical subsystem through the void in the collecting lens of the first optical subsystem.

28. The method of claim 26, wherein the first detecting detects an intensity of light scattered from a feature or deposit on the surface under inspection at one or more angles.

29. The method of claim 28, wherein the first detecting detects an image of the light returned from the feature or deposit in at least one dimension.

30. The method of claim 27, wherein the second detecting performs an interferometric measurement.

31. The method of claim 27, wherein the second detecting performs a deflection measurement.

32. The method of claim 26, wherein the collecting lens of the first optical subsystem further defines a second void passing through the collecting lens and devoid of any lens material, and wherein the method further comprises measuring a second characteristic of the surface under inspection using a second optical subsystem by second detecting a characteristic of light returned from the surface under inspection to a second detector of the second optical subsystem through the second void in the collecting lens of the first optical subsystem.

33. The method of claim 26, wherein the surface under inspection is a top surface of a transparent object, and wherein the method further comprises determining a change in depth of scattering from the transparent object beneath the surface under inspection as variation in the intensity across a detection field of the detecting.

34. An optical inspection head, comprising:
an illumination subsystem for directing an illumination beam at a surface under inspection;
a first optical subsystem for measuring a first characteristic of the surface under inspection, wherein the first optical subsystem includes a collecting lens for collecting light returned from the surface under inspection from the illumination beam and a detector for detecting an intensity of the light collected by the collecting lens, wherein the collecting lens defines a void passing through the collecting lens and devoid of any lens material, and wherein the illumination subsystem directs the illumination system through the void passing through the collecting lens; and
a profilometer for measuring a height of the surface under inspection, wherein light returned from the surface under inspection to the profilometer passes through the void in the collecting lens of the first optical subsystem.
